(19) United States
(12) Patent Application Publication
(10) Pub. No.: US 2002/0071791 A1
(43) Pub. Date: Jun. 13, 2002

(54) Catalytic converter

(76) Inventors: Michael Ralph Foster, Columbiaville, MI (US); Egas Jose Desousa, Grand Blanc, MI (US)

Correspondence Address: DELPHI TECHNOLOGIES, INC., Legal Staff, P.O. Box 5052, Mail Code: 480-414-420, Troy, MI, 48007-5052, US

(21) Appl. No.: 09/737,441

(22) Filed: Dec. 13, 2000

(51) Int. Cl. B01D 50/00; B01D 53/34; F01N 3/00

(52) U.S. Cl. 422/179; 422/168

(57) ABSTRACT

An endcone assembly for use with a catalytic converter comprises a conical shaped sidewall extending outward to a shoulder having a first diameter. A mat protection element having a second diameter extends from the shoulder. The mat protection element has a second diameter that is equivalent to or less than the diameter of the conical shaped sidewall. The mat protection element includes a sidewall having at least two ribs or dimples that protrude outwardly from the sidewall to impart additional retention, positioning and alignment properties to the endcone assembly when being placed within a catalytic converter assembly. The edge of the sidewall either contacts a leading edge of the mat support material, or penetrates the leading edge of the mat support material, when the endcone assembly is disposed within the catalytic converter.

### TECHNICAL FIELD

The disclosure relates to exhaust system components and, more particularly, to an endcone design for an exhaust system component.

### BACKGROUND

Catalytic converters are universally employed for oxidation of carbon monoxide and hydrocarbons and reduction of nitrogen oxides in exhaust gas streams. A catalyst supported by a catalyst substrate, disposed within the catalytic converter, facilitates the oxidation and reduction process of the exhaust gas stream. Catalyst substrates tend to be frangible and have coefficients of thermal expansion differing markedly from their metal, usually stainless steel, shells. As a result, the mounting means of the catalyst substrate must provide resistance to mechanical shock, due to impact and vibration, and to thermal shock, due to thermal cycling. Both thermal and mechanical shock may cause deterioration of the mat support material, which once started, quickly accelerates and ultimately renders the catalytic converter useless. Various intumescent and non-intumescent sheets or mat support materials have been found adequate as mounting materials for this purpose.

Intumescent sheet mounting materials do an adequate job of holding the catalyst substrate in place while resisting erosion at moderate exhaust temperatures, and moderate pressure pulsations of the exhaust gas. However, with smaller, four cylinder engines running at higher rotational velocities and catalytic converters being moved forward for quicker light-off times, present mounting materials are being subjected to much higher exhaust gas temperatures. Under these conditions, over a period of time, present mat support materials can be eroded.

There are several conventional catalytic converter designs typically employed, and, more particularly, three designs that are more commonly known, such as the standard internally insulated converter, close-coupled converter, and manifold mounted converter. All three designs utilize dual walled endcone assemblies having both inner end cone and outer end cone walls. Each endcone assembly includes insulation material such as INTERAM® 100 mat support material or INTERAM® 1100 HT, which are both manufactured by 3M® in Minneapolis, Minn. INTERAM® 1100 HT is a silica-alumina blend of long fibers that is known for its ability to withstand erosion.

These catalytic converter designs employ additional insulation material for specific catalytic converter applications. Such applications may require the catalytic converter to operate over a prolonged time frame at temperatures up to about and possibly exceeding 1,000° C. However, employing a dual walled endcone under typical operating conditions (about 250° C. to about 850° C.) is unnecessary when a single wall design can cool more quickly. In addition, employing dual walled endcone assemblies containing additional insulation material is expensive.

Consequently, there is a need to provide a low cost alternative catalytic converter design that reduces mat erosion and thermal deterioration of the mat support material during operation of the catalytic converter.

### SUMMARY

The drawbacks and disadvantages of the prior art are overcome by the exhaust system component, the catalytic converter assembly, and its method of manufacture described herein. The exhaust component assembly comprises a conical shaped sidewall extending outward to a shoulder. A mat protection element extends from the shoulder, away from the sidewall. The shoulder is secured to an exhaust system component.

The catalytic converter comprises a mat material concentrically disposed around a catalyst substrate and between the catalyst substrate and a shell. The shoulder of the endcone assembly is in physical contact with the shell. The mat protection element, which is disposed within the shell, optionally contacts or penetrates the leading edge of the mat support material.

The method for manufacturing the catalytic converter comprises disposing a catalyst substrate concentrically within a shell. A mat support material is disposed concentrically in between the catalyst substrate and shell. The endcone assembly is secured to the shell at the shoulder such that the endcone assembly and catalytic converter are in physical contact and fluid communication with one another.

### BRIEF DESCRIPTION OF THE DRAWINGS

Referring now to the figures, which are meant to be exemplary, not limiting, and wherein like elements are numbered alike in the several Figures.

FIG. 1 is a standard internally insulated catalytic converter assembly utilizing a dual walled endcone assembly of the prior art.

FIG. 2 is a close-coupled catalytic converter assembly utilizing a dual walled endcone assembly of the prior art.

FIG. 3 is a manifold mounted catalytic converter assembly utilizing a dual walled endcone assembly of the prior art.

FIG. 4 illustrates a cross-sectional view of an embodiment of an endcone assembly.

FIG. 5 illustrates a cross-sectional view of another embodiment of an endcone assembly.

FIG. 6 illustrates a cross-sectional view of an alternative embodiment of the endcone assembly of FIG. 4.

FIG. 7 illustrates a cross-sectional view of an alternative embodiment of the endcone assembly of FIG. 5.

FIG. 8 illustrates a cross-sectional view of another alternative embodiment of the endcone assembly of FIG. 4.

FIG. 9 illustrates a cross-sectional view of another alternative embodiment of the endcone assembly of FIG. 5.

FIG. 10 illustrates a cross-sectional view of an embodiment of a catalytic converter employing the endcone assembly of FIG. 4, and an endplate.

FIG. 11 illustrates a cross-sectional view of an embodiment of a catalytic converter employing the endcone assembly of FIG. 5, and an endplate.

FIG. 12 illustrates a cross-sectional view of an embodiment of a catalytic converter employing the endcone assembly of FIG. 6, and a conventional single walled endcone assembly.

FIG. 13 illustrates a cross-sectional view of an embodiment of a catalytic converter employing the endcone assembly of FIG. 7, and a spinformed conical end.

FIG. 14 illustrates a cross-sectional view of an embodiment of a catalytic converter employing the endcone assembly of FIG. 8, and an exhaust manifold cover.

FIG. 15 illustrates a cross-sectional view of an embodiment of a catalytic converter employing the endcone assembly of FIG. 9, and an exhaust manifold cover.

FIG. 16 illustrates a cross-sectional view of an alternative embodiment of the endcone assembly of FIG. 5.

FIG. 17 illustrates a cross-sectional view of a catalytic converter employing the endcone assembly of FIG. 16, and an endplate.

### DESCRIPTION OF THE PREFERRED EMBODIMENT

The endcone assembly described herein comprises a conical shaped sidewall extending outward to a shoulder. A mat protection element extends from the shoulder, and comprises a sidewall that is concentrically disposed within an exhaust system component such as a catalytic converter, sulfur and/or particulate matter trap, or a canister/container. The mat protection element can include at least two protrusions (e.g., ribs, dimples, and the like, as well as combinations comprising at least one of the foregoing protrusions) that can preferably retain, position, and align the endcone assembly within a catalytic converter shell relative to the catalyst substrate. The mat protection element can further include an edge that contacts a leading edge of the mat support material, or penetrates at least a portion of the mat support material, as the endcone assembly is disposed within the catalytic converter.

The contoured endcone assembly can be manufactured using conventional sheet metal techniques. For example, a conical shaped sidewall can be die formed from any suitable conventional sheet metal. One end can be further die formed, or can undergo a secondary sizing operation, to form the mat protection element having a second diameter. The first diameter of the conical shaped sidewall can be about equivalent to, or about greater than the second diameter of the mat protection element. In the alternative to die forming sheet metal, a conical shaped sidewall can be die formed from sheet metal such that the resulting conical shaped sidewall's diameter is about equivalent to, or about greater than the diameter of the mat protection element. Further to the formation of the contoured endcone assembly, expanding a portion of the conical shape located above the mat protection element can form the attachment element. One technique for forming the attachment element can comprise expanding an elastic material against said portion from within the endcone assembly's interior while the assembly is held in place.

An alternative method for forming the contoured endcone assembly comprises die forming a conical shaped sidewall from any suitable conventional sheet metal. A first end of the conical shaped sidewall can be sized to form a first diameter. The opposing second end can be sized to form a second diameter. Both the first end and second end can be further sized so that the endcone assembly can be attached to an exhaust system component at one or both ends. The second end can be sized further such that the attachment element and mat protection element can be formed. The resulting mat protection element at the second end can have a second diameter that is about equivalent to, or about less than the diameter of the first end.

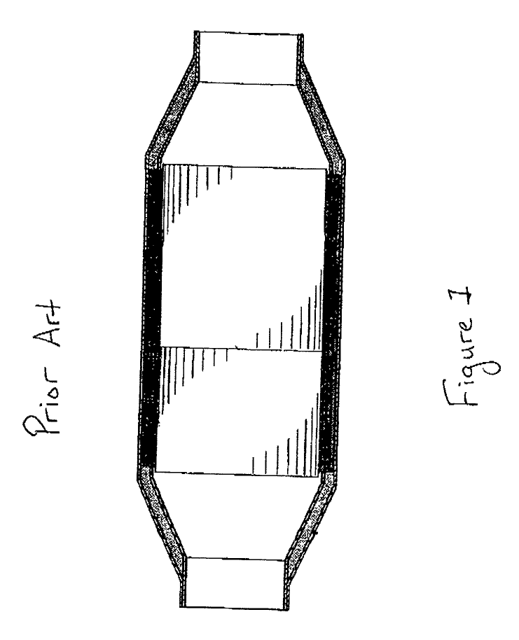

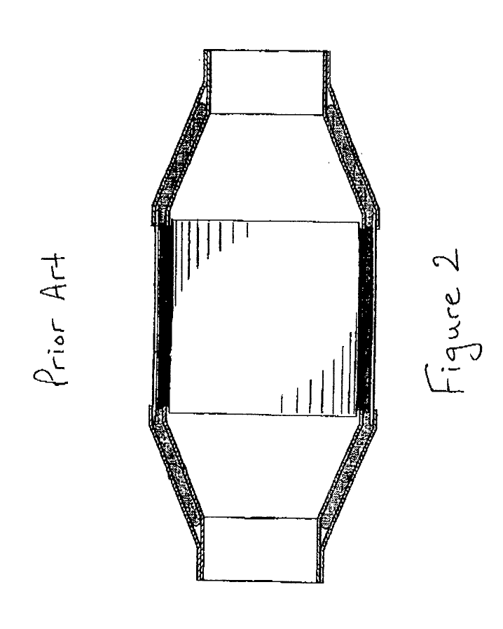

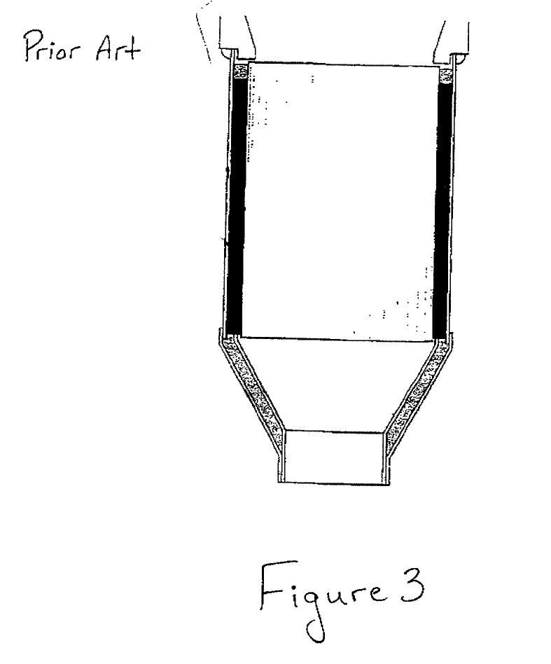

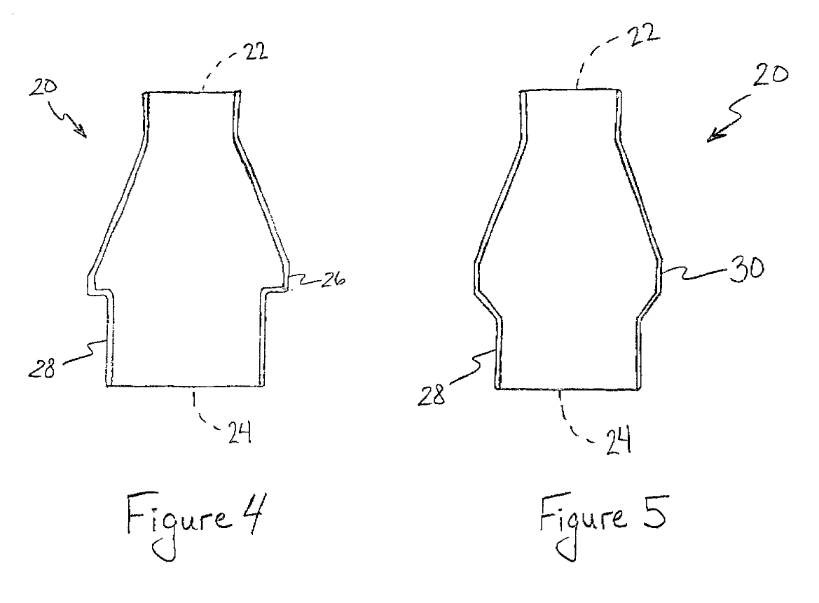

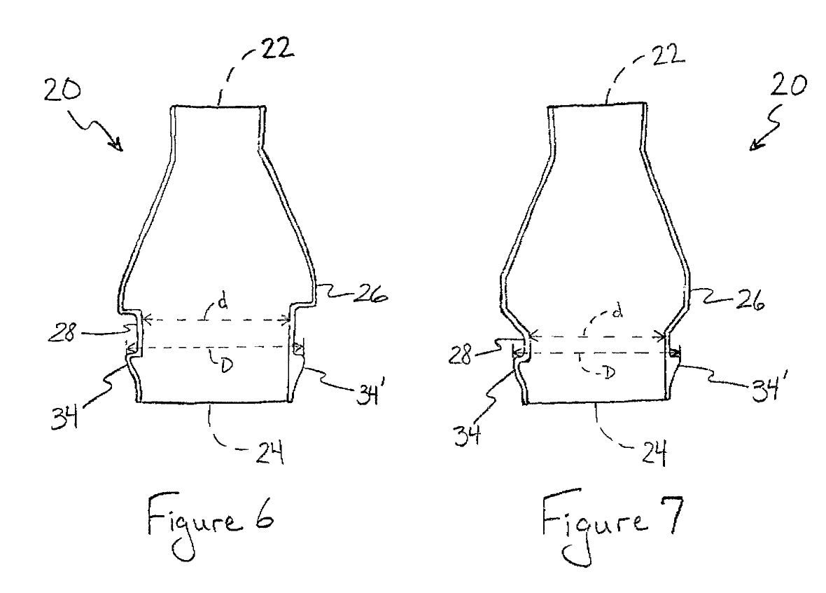

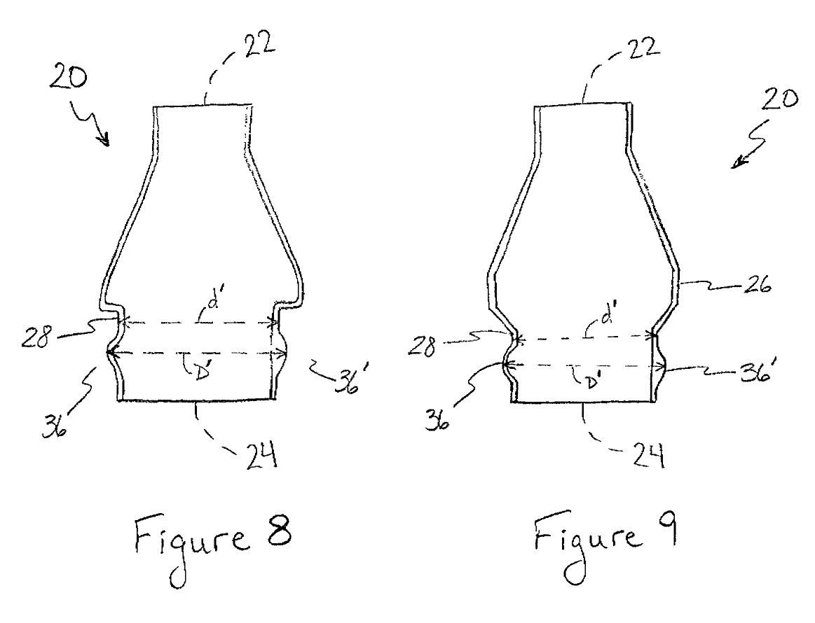

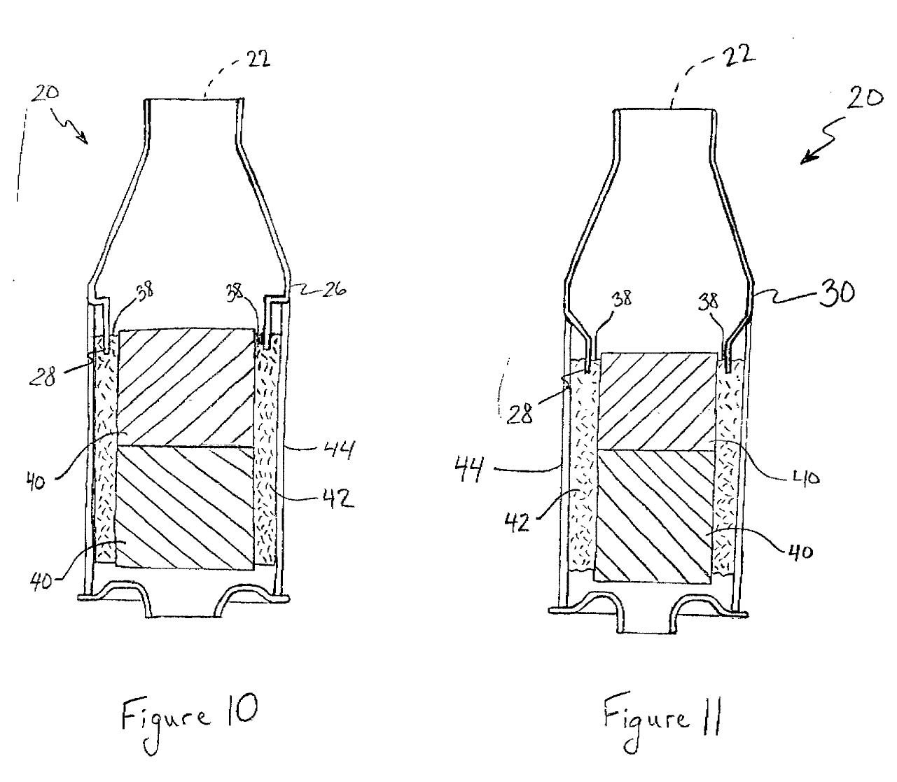

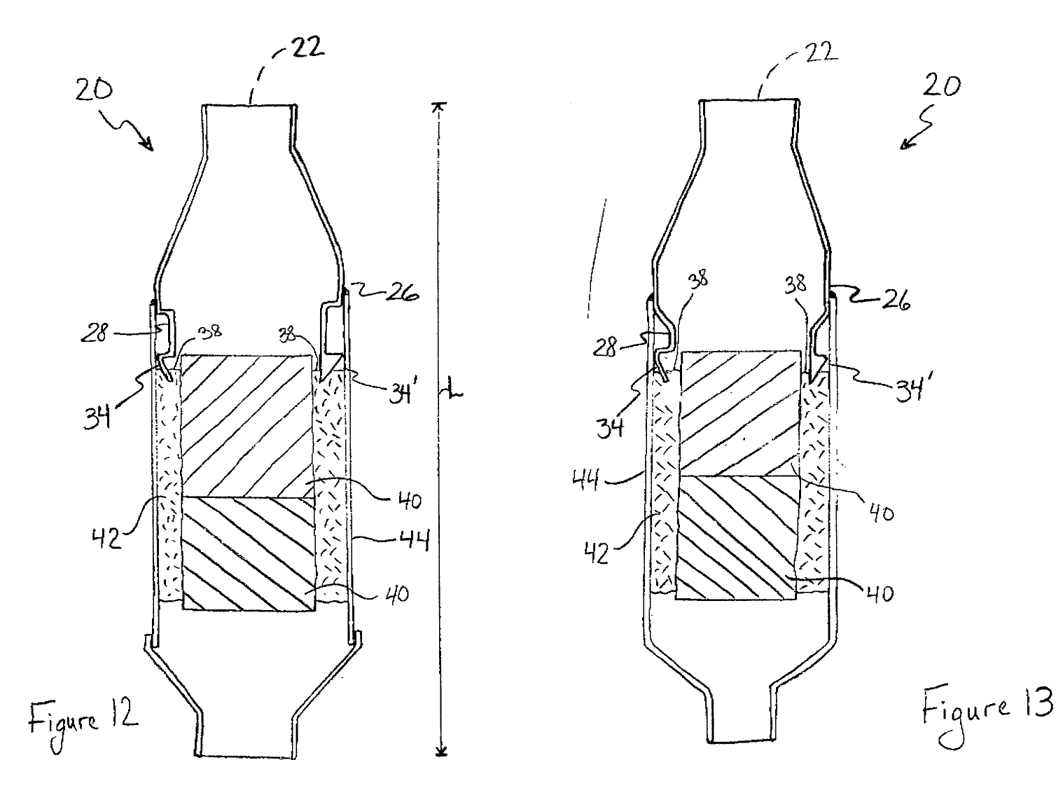

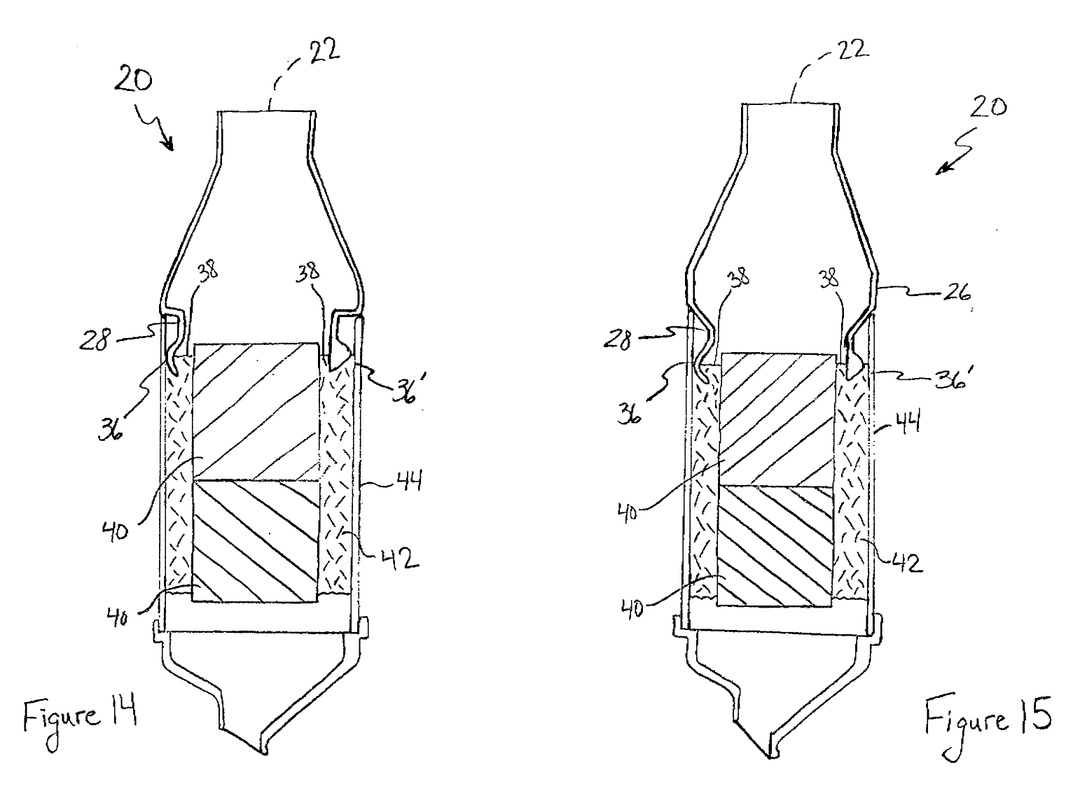

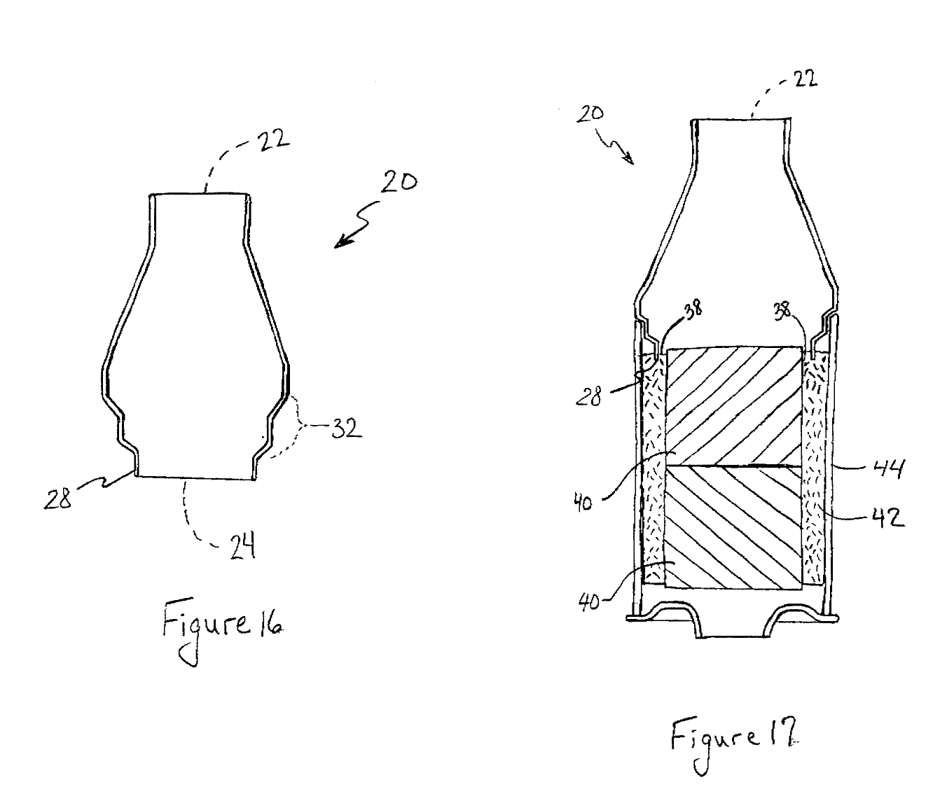

Referring generally to FIGS. 4-9, the contoured endcone assembly 20 comprises a conical shaped sidewall extending outward to a shoulder element. A mat protection element extends from and is contiguous to the shoulder element. The conical shaped sidewall can be configured to form an inlet 22 at a first end, while the mat protection element can be configured to form an outlet 24 at an opposing second end. The shoulder element can be, for example, a first shoulder 26 (See FIGS. 4, 6, 8) or a second shoulder 30 (See FIGS. 5, 7, 9), or a third shoulder 32 (See FIGS. 16, 17). The shoulders 26, 30, 32 are formed concentrically about their respective sidewalls, above the outlet 24, and can be attached to an exhaust system component, such as a catalytic converter using, for example, a joint configuration such as a lap joint, butt joint, tee joint, snap connector, and the like, as well as combinations comprising at least one of the foregoing joints, which can be sealed mechanically or by a sealing agent such as a weld, crimp, lockseam, bonding agent, and the like, or by a combination of techniques comprising at least one of the foregoing sealing agents. The shoulders 26, 30 and 32 can be utilized to position the endcone assembly relative to the catalytic converter's shell.

In one embodiment of the contoured endcone assembly 20, the mat protection element can be a sidewall sidewall that is concentrically formed about the outlet 24. The sidewall of the mat protection element can have a geometry such as annular (e.g., circular, or non-circular, such as oval, oblong, and the like), multi-sided (e.g., triangular, rectangular, pentagonal, hexagonal, heptagonal, octagonal, and the like), or a delta shape as is known in the art. In another embodiment of the contoured endcone assembly 20, the sidewall of the mat protection element can have a straight edge, such as the straight-edged annular sidewall of FIGS. 4 and 5, or can be disposed inwardly such as a concentric inwardly disposed sidewall, or a concentric inwardly disposed conical shaped sidewall as illustrated in FIGS. 16 and 17. In yet another embodiment, the sidewall can possess a combination of the above-mentioned features such that the sidewall can include a multi-sided geometry, such as rectangular, having straight-edged, or inwardly disposed sidewalls. In additional embodiments, the mat protection element can optionally include at least two ribs 34 (FIGS. 6-7) or dimples 36 (FIGS. 8-9), which protrude outwardly from the mat protection element, that impart additional positioning, retention, and alignment properties to the contoured endcone assembly when inserted into the catalytic converter assembly. The length of the mat protection element can be increased or decreased dependent upon the degree of the thermal protection sought for the edge of the mat support material. The mat protection element's length can be increased, for example, when the exhaust gas stream temperature is high, such as over about 850° C. In that situation, the mat protection element can extend to contact the mat support material, or penetrate the mat support material, and be disposed between the mat support material and the catalyst substrate. However, the degree of thermal protection, or temperature control, sought ultimately depends upon the particular operating conditions, and therefore may vary substantially with each particular application.

Referring now to FIGS. 6-7, contoured endcone assembly 20 includes a mat protection element having a single concentric rib, or preferably at least two ribs 34, with at least three ribs 34 most preferred, that protrude outwardly from the element's sidewall. The diameter “D” of the ribs 34 is preferably greater than the diameter “d” of the non-expanded portion of the mat protection element. The diameter “D” can be also slightly greater than the diameter of the catalytic converter shell, such that the ribs can contact the shell to ensure the endcone assembly is positioned, aligned and retained within the shell. Two ribs can be utilized for retaining, positioning and aligning the endcone assembly in the shell without using a weld, or other costly or time consuming techniques. However, three or more ribs can preferably be employed for retaining, positioning and aligning the endcone assembly, and its annular ring, within the shell, and relative to the catalyst substrate. The ribs 34 can be formed by stretching the stock material using, for example, a sizing tool. The ribs 34 can be formed to longitudinally align with the passage of the exhaust gas stream through, for example, a catalytic converter. In addition, the ribs 34 can be hollow 34, or can be solid such as ribs 34′.

Referring now to FIGS. 8-9, yet another contoured endcone assembly has a mat protection element that includes a single concentric dimple, or preferably at least two dimples 36, with at least three dimples 36 most preferred, that protrude outwardly from the element's sidewall. The diameter “D^{I}” of the dimples 36 is preferably greater than the diameter “d^{I}” of the non-expanded portion of the mat protection element. The diameter “D^{I}” can also be slightly greater than the interior diameter of the catalytic converter shell, such that the dimples can contact the shell to ensure the endcone assembly is positioned, aligned and retained within the shell. Two dimples can be utilized for retaining, positioning, and aligning the endcone assembly in the shell without using a weld, or other costly or time consuming techniques. However, three or more dimples can preferably be employed for retaining, positioning, and aligning the endcone assembly, and its annular ring, within the shell, and relative to the catalyst substrate. The dimple 36 can be formed by bending or stretch forming the stock material, or using a sizing tool. Each dimple 36 can be a solid extension, such as, e.g., dimple 36′, or a hollow extension and preferably have a depth proportional to the size and shape/geometry of the mat protection element.

The contoured endcone assembly can be manufactured using conventional sheet metal techniques. For example, a conical shaped sidewall can be die formed from any suitable conventional sheet metal. One end of the conical shaped sidewall can be further die formed, or can undergo a secondary sizing operation to form the mat protection element, such as the straight edged annular sidewall 28. In the alternative to die forming sheet metal, a conical shaped sidewall can be die formed from sheet metal such that the resulting conical shape's diameter is about equivalent to, or about greater than the diameter of the mat protection element. Further to the formation of the contoured endcone assembly, expanding a portion of the conical shape located above the mat protection element can form the attachment element, such as shoulders 26 and 30. One technique for forming the attachment element can comprise expanding an elastic material against said portion from within the endcone assembly's interior while the assembly is held in place.

An alternative method for forming the contoured endcone assembly comprises die forming the conical shaped sidewall from any suitable conventional sheet metal. One end of the conical shaped sidewall can be sized to have a first diameter, and form an inlet. The opposing end can be sized to have a second diameter, and form an outlet. Both the inlet and outlet can be sized so that the endcone assembly can be attached to an exhaust system component at one or both ends. The outlet can be sized further such that the attachment element, such as shoulders 26 and 30, and mat protection element, such as the straight edged annular sidewall 28, can be formed. The resulting mat protection element can have a second diameter that is about equivalent to, or about less than the first diameter of the conical shaped sidewall.

During assembly of the catalytic converter, the contoured endcone assembly 20 can be inserted into the catalytic converter such that the mat protection element engages the mat support material. For instance, the straight edged annular sidewall 28 can be inserted into the catalytic converter to make contact with a leading edge 38 of the mat support material (not shown). In contrast, the straight edged annular sidewall can also be inserted to penetrate the leading edge 38 of the mat support material (See FIGS. 10-15). Likewise, as the mat protection ring element either makes contact or penetrates the mat support material, the ribs 34 or dimples 36 can either be positioned above the mat support material, make contact with the mat support material or penetrate the mat support material (See FIGS. 10-15).

In addition, the distance in which the contoured endcone assembly 20 can be inserted within the catalytic converter shell can vary according to the particular application. The contoured endcone assembly 20 can be inserted a predetermined distance within the shell such that the total length “L” of the catalytic converter assembly can vary (See FIG. 12). For example, the contoured endcone assembly 20 can be inserted within the catalytic converter shell, such that the endcone assembly can be inserted farther into or pulled outward from the shell. Likewise, the mat protection element can be inserted farther into or pulled outward from the mat support material as the contoured endcone assembly 20 is inserted farther into or pulled outward from the catalytic converter shell. The contoured endcone assembly 20 can be welded at the juncture of its shoulder 26, as well as shoulders 30 and 32 in additional embodiments, with the catalytic converter shell, such that the shell overlaps the shoulder. More specifically, the shell preferably overlaps and is welded to the shoulder at the shoulder's greatest diameter.

Using a catalytic converter assembly as an example, the components making up the catalytic converter assembly possess certain tolerances with regard to pressure, temperature, stress, strain, and the like. By varying the catalytic converter assembly's length, the components can be relieved from experiencing certain stresses and strains. Thus, varying the length of the catalytic converter assembly can correct for certain tolerances possessed by the components comprising the catalytic converter assembly.

Once the contoured endcone assembly 20 is inserted into the shell, the catalytic converter can preferably be affixed to the shell using, for example, a mechanical operation, a welding operation, or a sealing operation, and the like. However, a welding operation is preferred since welding can be incorporated into the current manufacturing scheme without increasing costs and labor, or impeding efficiency. The endcone assembly 20 and shell can preferably be welded together in a single operation to achieve a gas tight assembly. The endcone assembly 20 can be welded at one or both ends of the catalytic converter shell using several different methods.

For example, a MIG weld can be placed where the attachment element of the endcone assembly 20 and shell make contact. MIG stands for Metal Inert Gas welding, many times called “Wire-feed”, and also referred as GMAW (Gas Metal Arc Welding). The “metal” refers to the wire, which is what is used to start the arc. It is shielded by inert gas and the feeding wire also acts as the filler rod. Likewise, a TIG weld (tungsten-inert gas weld) can also be used to sealingly secure the endcone assembly 20 and shell at the attachment element. TIG stands for Tungsten Inert Gas welding, and is also referred to as GTAW (Gas Tungsten Arc Welding). The arc is started with a tungsten electrode shielded by inert gas while a filler rod is fed into the weld puddle separately. A slower process than MIG, TIG welding produces a more precise weld and can be used at lower amperages for thinner metal and can be used on exotic metals. The TIG weld can allow one to undo the weld and restore the welded components to their original state without losing excess material in the process. In FIGS. 10-15, the contoured endcone assembly 20 can be secured to one or both ends of the catalytic converter using the attachment element and welded using a MIG weld and/or TIG weld, as well as other conventional welding techniques.

Catalytic converters are universally employed for catalytically treating environmentally unfriendly exhaust gas elements using a variety of catalysts disposed on a catalyst substrate. The catalyst substrate can comprise any material designed for use in a spark ignition or diesel engine environment, and have the following characteristics: (1) capable of operating at temperatures up to about 1,000° C., (2) capable of withstanding exposure to hydrocarbons, nitrogen oxides, carbon monoxide, carbon dioxide, and/or sulfur, and other exhaust gas constituents; and (3) having sufficient surface area and structural integrity to support the desired catalyst. Some possible materials include cordierite, silicon carbide, metallic foils, alumina sponges, porous glasses, and the like, and mixtures comprising at least one of the foregoing. Some ceramic materials include “HONEY CERAM”, commercially available from NGK-Locke, Inc, Southfield, Mich., and “CELCOR”, commercially available from Coming, Inc., Corning, N.Y.

Although the catalyst substrate can have any size or geometry, the size and geometry are preferably chosen to optimize the surface area in the given catalytic converter design parameters. Typically, the catalyst substrate has a honeycomb geometry, with the combs being any multi-sided or rounded shape, with substantially square, triangular, hexagonal, octagonal or similar geometries preferred due to the ease of manufacturing and increased surface area.

Disposed on and/or throughout the catalyst substrate is a catalyst for converting exhaust gasses to acceptable emissions levels as is known in the art. The catalyst may comprise one or more catalyst materials that are wash coated, imbibed, impregnated, physisorbed, chemisorbed, precipitated, or otherwise applied to the catalyst substrate. Possible catalyst materials include metals, such as platinum, palladium, rhodium, iridium, osmium, ruthenium, tantalum, zirconium, yttrium, cerium, nickel, copper, and the like, as well as mixtures, oxides and alloys comprising at least one of the foregoing, and other conventional catalysts.

Disposed concentrically around the catalyst substrate to form a mat support material/catalyst substrate subassembly is a mat support material that insulates the shell from both high exhaust gas temperatures and the exothermic catalytic reaction occurring within the catalyst substrate. The mat support material further enhances the structural integrity of the catalyst substrate by applying compressive radial forces about it, reducing its axial movement, and retaining it in place. The mat support material can comprise an insulating material such as ceramics, vermiculite, and the like, or other combinations comprising at least one of the foregoing, and other conventional materials such as an organic binder. The mat support material can either be a simple non-intumescent ceramic material, or an intumescent material, e.g., one which contains a vermiculite component that expands when heated to maintain firm compression when the shell expands outward from the catalyst substrate, as well as materials which include a combination of both. Typical non-intumescent ceramic materials include ceramic materials such as those sold under the trademarks “INTERAM® 100HT” by the “3M” Company, Minneapolis, Minn., or those sold under the trademark, “FIBERFRAX” and “CC-MAX” by the Unifrax Co., Niagara Falls, N.Y., and the like. Intumescent ceramic materials include ceramic materials such as those sold under the trademark “INTERAM® 100” by the “3M” Company, Minneapolis, Minn., as well as those intumescents which are also sold under the aforementioned “FIBERFRAX” trademark, as well as combinations thereof and others.

The mat support material/catalyst substrate subassembly can preferably be inserted into a catalytic converter shell. The shell includes at least one opening for the passage of an exhaust gas stream through the catalytic converter. One opening of the shell is preferably fitted with the contoured endcone assembly 20 and the opposing opening can be formed integrally with the shell or a second contoured endcone assembly 20, or conventional end cone, end plate, and the like, can be concentrically fitted about the opposing opening and secured to the shell to provide a gas tight seal using a means for securement such as, e.g., a welding operation. The choice of material for the shell depends upon the type of exhaust gas, the maximum temperature reached by the catalyst substrate, the maximum temperature of the exhaust gas stream, and the like. Suitable materials for the shell can comprise any material that is capable of resisting under-car salt, temperature and corrosion. Typically, ferrous materials are employed such as ferritic stainless steels. Ferritic stainless steels can include stainless steels such as, e.g., the 400 - Series such as SS-409, SS-439, and SS-441, with grade SS-409 generally preferred.

The mat support material/catalyst substrate subassembly can be disposed within a variety of shells using a means for insertion, such as, e.g., a stuffing cone. The stuffing cone is a device that compresses the mat support material concentrically about the substrate. The stuffing cone then stuffs the compressed mat support material/catalyst substrate subassembly into the shell, such that an annular gap preferably forms between the catalyst substrate and the interior surface of the shell as the mat support material becomes compressed about the catalyst substrate. In the alternative, for example, the shell can comprise two half shell components, also known as, and more commonly referred to as a clamshell design, that are compressed together about the mat support material/catalyst substrate subassembly, such that an annular gap preferably forms between the catalyst substrate and the interior surface of each half shell as the mat support material becomes compressed about the catalyst substrate. The ends of the shell can be sized so that the contoured endcone assembly 20, or an end cone, an end plate, an exhaust gas manifold assembly, or exhaust system component, and combinations comprising at least one of the foregoing, can be attached to provide a gas tight seal using, for example, a welding operation.

Alternatively, the shell can also have a non-circular geometry such as oval, oblong, and the like. Such non-circular shell designs can be manufactured by employing a contoured tube or a half shell design. Half shell designs can be manufactured using a die formed clamshell, which, when combined with another half, can form the non-circular desired geometry. The mat support material/catalyst substrate subassembly can be placed within one of the half shells prior to assembly of the catalytic converter. The other half shell can be attached to the half shell containing the mat support material/catalyst substrate subassembly, such that an annular gap preferably forms between the catalyst substrate and the interior surface of each half shell as the mat support material becomes compressed about the catalyst substrate. The half shells can be affixed together using, for example, a welding operation, and, preferably, a roller seam welding operation.

In another alternative embodiment of the shell, one end of the shell can be spin formed to resemble, preferably, a conical or frusto-conical shape. The spin forming method can comprise using a device having a plurality of forming rollers spaced at different distances from a spin axis, to spinform one end of the shell. The progression of the cylindrical shell through the forming rollers can achieve multiple reduction steps in the cylindrical shell to form the conical shaped end for attachment to an exhaust system component using, for example, a welding operation. At least one contoured endcone assembly 20, conventional endcone, endplate, exhaust manifold cover, or other exhaust system component, and combinations comprising at least one of the foregoing, can be secured to either one or both ends of either the circular shell or non-circular shell.

A catalytic converter employing the contoured endcone assembly can preferably be manufactured for a mobile vehicle's exhaust system by forming one or more catalyst substrates 40 comprising a catalyst, such as by extrusion or other conventional process, followed by deposition or other introduction of the catalyst. The mat support material 42 can be concentrically disposed around the catalyst substrates 40 with the combination then disposed concentrically within a shell 44 having a pair of ends, and an opening therebetween to allow for the passage of exhaust gas. Meanwhile, a contoured endcone assembly 20 comprising a conical shaped sidewall extending outwardly to a shoulder element, with a mat protection element extending from and contiguous to the shoulder element. The mat protection element can include a sidewall having at least three ribs or dimples to position, retain and align the endcone assembly within the shell relative to the catalyst substrate. The sidewall also includes a leading edge that can be inserted into the shell such that the edge can contact the mat support material or penetrate the mat support material.

The contoured endcone assembly is attached to the shell using the shoulder element such that the catalytic converter and contoured endcone assembly are in fluid communication. The contoured endcone can be further attached at its opposing end, using, for example, a mechanical operation, welding operation, or sealing operation, and the like, to an exhaust system component such as a connecting pipe, a mounting flange, a flexible coupling assembly, an exhaust pipe, or other exhaust system component, and the like, to place the endcone assembly in fluid communication with an exhaust system. The opposing end of the shell 44, opposite the endcone assembly, can be attached, using, for example, a mechanical operation, a welding operation, or a sealing operation, and the like, to an end plate 24, conventional endcone (not shown), or other type of cover, and further attached to an exhaust system component to place the catalytic converter in fluid communication with the exhaust system.

The contoured endcone assembly possesses several advantages over those catalytic converter designs illustrated in FIGS. 1-3. First, a catalytic converter design incorporating the contoured endcone assembly improves its durability over those designs shown in FIGS. 1-3. The contoured endcone assembly eliminates the need to weld an inner endcone (of a dual walled endcone assembly) to either the outer endcone or the catalytic converter shell, while also eliminating a part from the catalytic converter assembly. As a result, the catalytic converter assembly weighs less. In addition, as the catalytic converter assembly ages through use, the elimination of an extra weld reduces a possible location where the structural integrity of the assembly may be compromised.

The contoured endcone assembly also costs less to manufacture than those endcone assemblies shown in FIGS. 1-3. The contoured endcone assembly can be die formed, pierced, and extruded using conventional techniques and sizing operations. In contrast, the endcone assemblies, illustrated in FIGS. 1-3, require a die to form both the outer and inner endcones, and a series of welding steps to assemble the dual walled endcone assembly. Using this die process increases manufacturing costs by introducing steps requiring additional time, labor and costs, as well as creating additional dunnage of stock material. The manufacturing process for the endcone utilizes conventional techniques and sizing operations to form the single walled endcone, such as, e.g., die formed and sizing operations. Consequently, the endcone costs less to manufacture than those conventional endcone assemblies illustrated in FIGS. 1-3.

The endcone assembly also serves as an alternative to dual walled endcone assemblies while providing comparable insulative properties. Conventional exhaust systems employ insulated and non-insulated pipes for attachment to catalytic converters according to the operating conditions. When operating conditions are not severe enough to require additional insulation, the endcone assembly can still provide adequate insulation to prevent thermal deterioration of the mat support material without the additional costs associated with using insulation material.

More particularly, the annular sidewall of the contoured endcone acts as an insulator by preventing the exhaust gas stream from directly impinging upon the mat support material or the remaining exposed interior surface of the shell. The mat support material and shell will not continuously experience the high temperature exhaust gas stream entering the catalytic converter due to the annular sidewall. As a result, the expansion of the mat support material will also be lessened due to the lower temperature, which, in turn, can prevent deformation of the shell. The mat support material is also less likely to experience erosion and/or thermal deterioration due to the annular sidewall. The annular sidewall provides a more efficient and cost effective method for insulating the shell of the catalytic converter than using additional expensive insulation material.

Furthermore, the embodiments of the contoured endcone assembly can include protrusion(s) to position, retain, and align the contoured endcone assembly within the shell, and relative to the catalyst substrate, as well as reinforce the catalytic converter assembly's structure. The contoured endcone assembly can be inserted, retained by the protrusions, and subsequently aligned to ensure accurate positioning within the shell prior to welding. As a result, considerable time and cost benefits can be realized using this contoured endcone assembly.

Lastly, the embodiments of the contoured endcone assembly can be employed as a cover for not only catalytic converters, but for other exhaust system components as well. Possible exhaust system components can include traps, e.g., sulfur and/or particulate matter, as well as containers, e.g., for housing adsorber materials and/or collecting gas or gaseous constituents, and the like. The contoured endcone assembly can place these exhaust system components in fluid communication with the exhaust system. In addition, the contoured endcone assembly can be fitted to, e.g., a trap or container, such that the trap's or container's overall length can be adjusted to accommodate certain component tolerances and relieve certain strains and stresses associated with those components of the trap or container. And finally, the contoured endcone assembly's attachment element and mat protection element designs can also be applied to endcone assemblies having multi-sided geometries such as rectangular, and the like, or delta shapes as is known in the art.

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. An exhaust system component, comprising:
a conical shaped sidewall extending outward to a shoulder; and
a mat protection element extending from said shoulder, away from said sidewall;
wherein said shoulder secures to an exhaust system component.

2. The exhaust system component of claim 1, wherein a shoulder diameter is greater than a mat protection element diameter.

3. The exhaust system component of claim 1, wherein said shoulder diameter is equivalent to said mat protection element diameter.

4. The exhaust system component of claim 1, wherein said mat protection element has a conical geometry extending inward from said shoulder.

5. The exhaust system component of claim 1, wherein said mat protection element has a conical geometry extending outward from said shoulder.

6. The exhaust system component of claim 1, wherein said mat protection element has a cylindrical geometry.

7. The exhaust system component of claim 1, wherein said mat protection element further comprises a protrusion.

8. The exhaust system component of claim 7, wherein said protrusion is selected from the group consisting of a rib a dimple, and combinations comprising at least one of the foregoing protrusions.

9. The exhaust system component of claim 7, wherein said protrusion is longitudinally disposed on said mat protection element.

10. A catalytic converter, comprising:
a catalyst substrate comprising a catalyst;
a shell concentrically disposed around said catalyst substrate;
a mat support material disposed between said catalyst substrate and said shell, and concentrically around said catalyst substrate;
an endcone assembly comprising a conical shaped sidewall extending outward to a shoulder and a mat protection element extending from said shoulder, away from said sidewall, wherein said endcone assembly is securedly attached to said shell at said shoulder.

11. The catalytic converter of claim 10, wherein an end of said mat protection element contacts at least an edge of said mat support material.

12. The catalytic converter of claim 10, wherein at least a portion of said mat protection element penetrates at least a portion of said mat support material.

13. The catalytic converter of claim 10, wherein said mat protection element further comprises at least two protrusions extending from said mat protection element to said.

14. The catalytic converter of claim 13, wherein said protrusion is selected from the group consisting of a rib a dimple, and combinations comprising at least one of the foregoing protrusions.

15. A method for manufacturing a catalytic converter, comprising:
concentrically disposing a catalyst substrate in a shell;
disposing concentrically a mat support material between said catalyst substrate and said shell, and around said catalyst substrate;
securing a shoulder of an endcone assembly to said shell, said endcone assembly comprising conical shaped sidewall extending outward to a shoulder and a mat protection element extending from said shoulder.

16. The method of claim 15, further comprising disposing concentrically said mat protection element within said shell, and between said catalyst substrate and said shell.

17. The method of claim 15, further comprising engaging said shell with at least two protrusions from said mat protection element.

18. The method of claim 17, wherein said protrusion is selected from the group consisting of a rib a dimple, and combinations comprising at least one of the foregoing protrusions.

19. The method of claim 15, further comprising contacting at least a leading edge of said mat support material with said mat protection element.

20. The method of claim 19, further comprises penetrating at least a portion of said mat support material with at least a portion of said mat protection element.
